(19) United States
(12) Patent Application Publication
(10) Pub. No.: US 2025/0384628 A1
(43) Pub. Date: Dec. 18, 2025

(54) INTERACTIVE 3D VISUALIZATION SYSTEM FOR 3D OBJECTS AND A METHOD THEREOF

(71) Applicant: International Institute of Information Technology, Hyderabad, Hyderabad (IN)

(72) Inventors: Jayanthi Sivaswamy, Hyderabad (IN); P.J. Narayanan, Hyderabad (IN); Pawan Harish, Dwarka (IN); Mythri Venkatesh, Bengaluru (IN)

(21) Appl. No.: 19/072,246

(22) Filed: Mar. 6, 2025

(30) Foreign Application Priority Data
Jun. 13, 2024 (IN) 202441045913

(51) Int. Cl. G06T 17/20; G06T 19/20

(52) U.S. Cl. CPC G06T 17/20; G06T 19/20; G06T 2210/21; G06T 2210/41; G06T 2210/61; G06T 2219/2016

(57) ABSTRACT

Embodiments herein provide a processor-implemented method for generating and visualizing three-dimensional (3D) meshes of volumetric in-vivo images of anatomical structures. The processor-implemented method begins by segmenting medical imaging data, derived from magnetic resonance imaging (MRI) and computed tomography (CT) scans, into fine structures using segmentation techniques. Subsequently, voxel subdivision methods are applied to generate 3D meshes, representing the geometric characteristics of the segmented structures. A scene graph is then constructed to capture the spatial relationships and attributes, such as geometry or texture, of the 3D meshes. The scene graph facilitates rendering the 3D meshes, enabling visualization of structural connections at the node level, where each node corresponds to a specific fine structure. The 3D visualization system is delivered to user devices, supports enhanced analysis and understanding of complex anatomical relationships, making it particularly valuable for medical and educational applications.

### BACKGROUND

### Technical Field

The embodiments herein generally relate to an interactive visualization system, more particularly, a system and a method for generating three-dimensional (3D) meshes of volumetric in-vivo images of a structure and rendering the 3D mesh of each node connection in the structure for visualization.

### Description of the Related Art

Anatomical education has been dominated by methods such as volumetric illustrations, tangible models, and the dissection of cadavers, all pivotal in the realm of medical training. Despite their long-standing use, these methodologies are beset with challenges like inadequate representation of the intricate three-dimensional (3D) nature of human anatomy, incurring high costs and ethical dilemmas associated with cadaver use, and failure to integrate essential radiological anatomy, which is indispensable for modern medical diagnostics and practices.

Existing systems encompass online 3D anatomical atlases and virtual reality (VR) platforms. These advancements in the existing systems represent a leap forward from traditional methods by offering enhancements in anatomical visualization. However, the effectiveness of the existing systems is often limited by the inability to support scalable, interactive learning experiences for larger groups, and their general failure to incorporate actual patient imaging data, thus compromising the relevance and applicability of anatomy teaching in a clinical context.

Furthermore, the widespread adoption of the existing systems is hindered by financial and accessibility barriers, preventing their full integration into educational institutions. The dependency on specific hardware, such as VR headsets, constrains the scalability and practical application in educational settings. Furthermore, the existing systems fail to provide an interactive platform capable of concurrently presenting 3D anatomical structures and their radiological counterparts, essential for fostering a comprehensive understanding of anatomy.

Therefore, there arises a need to address the aforementioned technical drawbacks in the existing methods in finding scenic routes in 2-dimensional space with scenic beauty being an equidistant view of points of interest.

### SUMMARY

In view of the foregoing, an embodiment herein provides a processor-implemented method for generating three-dimensional (3D) meshes of volumetric in-vivo images of a structure and rendering the 3D mesh of each node connection in the structure for visualization. The processor-implemented method includes segmenting the volumetric in-vivo images of the structure into fine structures within the structure using at least one segmentation method. The volumetric in-vivo images of the structure are received from an image-capturing device. The volumetric in-vivo images comprising medical imaging data from a plurality of magnetic resonance imaging (MRI) scans and Computed tomography (CT) scans. The processor-implemented method includes generating 3D meshes of the segmented fine structures by applying a voxel sub-division method. Each 3D mesh is a representation of a geometric structure of the segmented fine structures areas. The processor-implemented method includes constructing a scene graph representation of the 3D meshes by combining the spatial relationships of the 3D mesh. The processor-implemented method includes rendering the 3D mesh of the structure by rendering the scene graph representation and analysing the connections of nodes within the scene graph representation. Each node represents fine structures with attributes comprising at least one of geometry, or texture. The processor-implemented method includes providing the 3D meshes of each node connection on a user device for visualization.

In some embodiments, the processor-implemented method further includes aligning the 3D mesh of the node with the corresponding segmented volumetric in-vivo images to ensure accurate spatial relationships in the scene graph representation.

In some embodiments, the processor-implemented method further includes enabling a user to interact with the 3D meshes on the user device, wherein the user interaction comprises actions for rotating, zooming, selecting, or modifying the 3D meshes.

In some embodiments, the processor-implemented method further includes updating the scene graph representation and the visualization of the 3D meshes in response to the user interaction to reflect real-time changes to the 3D meshes.

In some embodiments, the processor-implemented method further includes exporting the scene graph representation in an advanced user visualization (AVU) format for storing or sharing the current state of the 3D meshes.

In some embodiments, the processor-implemented method further includes pre-processing the volumetric in-vivo images using at least one preprocessing technique. At least one preprocessing technique is selected from a normalization method, a contrast adjustment method, or artifact removal method.

In some embodiments, the processor-implemented method further includes at least one segmentation method is selected from Brain Suite, Free Surfer, and ITK-Snap.

In some embodiments, the processor-implemented method further includes incorporating additional data including tractography and volume images into the scene graph representation to provide context for the 3D meshes.

In some embodiments, the processor-implemented method includes generating the 3D mesh from the segmented fine structures by, dividing the segmented fine structures into a one or more equal-sized cubic units or voxels. The processor-implemented method includes identifying whether neighboring voxels belong to the same segmented structure or different segmented structures. The processor-implemented method includes determining intersection points along voxel edges where transitions occur between the segmented fine structures for the plurality of voxels belonging to different segmented structures. The processor-implemented method includes constructing sub-surfaces between the identified intersection points and corresponding voxel positions to define boundary regions. The system includes aggregating the generated sub-surfaces to construct the 3D mesh representing the boundary of the segmented structure.

In one aspect, an embodiment herein provides a system for generating three-dimensional 3D) meshes of volumetric in-vivo images of a structure and rendering the 3D mesh of each node connection in the structure for visualization. The system includes a server that receives volumetric in-vivo images of a structure through an image-capturing device, wherein the volumetric in-vivo images comprising medical imaging data from a plurality of magnetic resonance imaging (MRI) scans and computed tomography (CT) scans. The server includes a memory and a processor. The memory stores a set of instructions. The processor is configured to execute the set of instructions. The processor is configured to segment the volumetric in-vivo images into fine structures within the structure using at least one segmentation method. The processor is configured to generate 3D meshes of the segmented fine structures by applying a voxel sub-division method, wherein the 3D meshes are a representation of a geometric structure of the segmented fine structures areas. The processor is configured to construct a scene graph representation of the 3D meshes by combining spatial relationships of the 3D meshes. The processor is configured to render the scene graph representation through a renderer module by analysing nodes within the scene graph representation. each node represents fine structures with attributes comprising at least one of geometry, or texture. generating a visualization of the 3D meshes on a user device based on the analysed node. The processor is configured to render the scene graph representation through a renderer module by generating a visualization of the 3D meshes on a user device based on the analysed node.

In some embodiments, the processor is configured to align the 3D mesh of the node with the corresponding segmented volumetric in-vivo images to ensure accurate spatial relationships in the scene graph representation.

In some embodiments, the processor configured to enable a user to interact with the 3D meshes on the user device. The user interaction comprises actions for rotating, zooming, selecting, or modifying the 3D meshes.

In some embodiments, the processor configured to update the scene graph representation and the visualization of the 3D meshes in response to the user interaction to reflect real-time changes to the 3D meshes.

In some embodiments, the processor configured to export the scene graph representation in an advanced user visualization (AVU) format for storing or sharing the current state of the 3D meshes.

In some embodiments, the processor configured to pre-process the volumetric in-vivo images using at least one preprocessing technique. At least one preprocessing technique is selected from a normalization method, a contrast adjustment method, or artifact removal method.

In some embodiments, the processor configured to select at least one segmentation method from Brain Suite, Free Surfer, and ITK-Snap.

In some embodiments, the processor configured to incorporate additional data including tractography and volume images into the scene graph representation to provide context for the 3D meshes.

In some embodiments, the processor configured to generate the 3D mesh from the segmented fine structures by dividing the segmented fine structures into a one or more equal-sized cubic units or voxels. The processor configured to identify whether neighboring voxels belong to the same segmented structure or different segmented structures. The processor configured to detect boundaries between the neighboring voxels belonging to different segmented structures. The processor configured to determine intersection points along voxel edges where transitions occur between the segmented fine structures for the plurality of voxels belonging to different segmented structures. The processor configured to construct sub-surfaces between the identified intersection points and corresponding voxel positions to define boundary regions. The processor configured to aggregate the generated sub-surfaces to construct the 3D mesh representing the boundary of the segmented structure.

In another aspect, one or more non-transitory computer-readable storage mediums store one or sequences of instructions, which when executed by one or more processors, causes a processor-implemented method for generating three-dimensional (3D) meshes of volumetric in-vivo images of a structure and rendering the 3D mesh of each node connection in the structure for visualization. The processor-implemented method includes segmenting the volumetric in-vivo images of the structure into fine structures within the structure using at least one segmentation method. The volumetric in-vivo images of the structure are received from an image-capturing device. The volumetric in-vivo images comprising medical imaging data from a plurality of magnetic resonance imaging (MRI) scans and Computed tomography (CT) scans. The processor-implemented method includes generating 3D meshes of the segmented fine structures by applying a voxel sub-division method. Each 3D mesh is a representation of a geometric structure of the segmented fine structures areas. The processor-implemented method includes constructing a scene graph representation of the 3D meshes by combining the spatial relationships of the 3D mesh. The processor-implemented method includes rendering the 3D mesh of the structure by rendering the scene graph representation and analyzing the connections of nodes within the scene graph representation. Each node represents fine structures with attributes comprising at least one of geometry, or texture. The processor-implemented method includes providing the 3D meshes of each node connection on a user device for visualization.

The processor-implemented method enables enhanced visualization and analysis of complex volumetric in-vivo images of the structure through the generation and rendering of highly accurate 3D meshes. By segmenting volumetric in-vivo images into fine structures and applying advanced techniques such as voxel subdivision or the marching cubes algorithm, the processor-implemented method ensures precise geometric representation of intricate anatomical details. The integration of spatial relationships into a scene graph allows for organized and hierarchical visualization, simplifying the analysis of node connections and structural attributes. Additionally, the system interactivity enables actions such as rotating, zooming, and modifying 3D meshes. The system provides an intuitive and dynamic user experience, with real-time updates to reflect changes. The system's ability to incorporate supplementary data, such as tractography and volume images, further contextualizes the 3D representations, enhancing multi-modal analysis. The system enhance image quality and accuracy in downstream processing as the system performs the preprocessing step. Furthermore, the export of scene graph representations in an Advanced Visualization User (AVU) format promotes seamless data sharing and storage for collaboration and future reference. The innovative approach supports applications in precision medicine, such as diagnostic imaging, surgical planning, and medical education, empowering healthcare professionals with accurate, interactive, and actionable insights. The system is designed in a modular way, meaning each part of the system is responsible for a specific task and communicates with other parts through a central module. This structure makes it easier to develop, update, or replace parts of the module as needed. The system handles different types of data (like static, dynamic, and volumetric data) while being lightweight and easy on system resources.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 illustrates a block diagram of a system for generating three-dimensional (3D) meshes of volumetric in-vivo images of a structure and rendering the 3D mesh of each node connection in the structure for visualization according to some embodiments herein;

FIG. 2 illustrates an exploded view of a server 106 of FIG. 1 according to some embodiments herein;

FIG. 3 illustrates workflow of system for the 3D visualization System according to some embodiment herein;

FIG. 4 is an exemplary diagram of a scenegraph representation of a brain according to some embodiment herein;

FIG. 5 illustrates Graphical User Interface (GUI) of the system, showcasing its renderer and interactive control panels according to some embodiments herein;

FIG. 6 illustrates a comparative visualization of a 3D brainstem model using a stereoscopic imaging system according to some embodiments;

FIG. 7 is a flow diagram that illustrates a method for generating three-dimensional (3D) meshes of volumetric in-vivo images of a structure and rendering the 3D mesh of each node connection in the structure for visualization according to some embodiments herein; and

FIG. 8 is a schematic diagram of a computer architecture in accordance with the embodiments herein.

### DETAILED DESCRIPTION OF THE DRAWINGS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

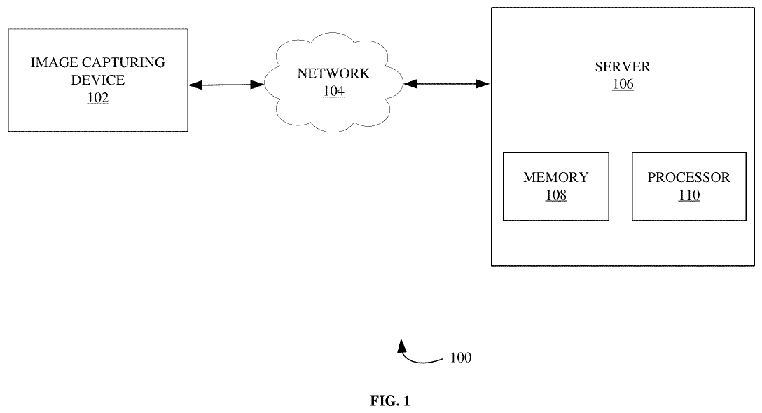

As mentioned, there is a need for a system and a method for generating three-dimensional (3D) meshes of volumetric in-vivo images of a structure and rendering the 3D mesh of each node connection in the structure for visualization. Referring now to the drawings, and more particularly to FIGS. 1 through 8, where similar reference characters denote corresponding features consistently throughout the figures, preferred embodiments are shown.

FIG. 1 illustrates a block diagram of a system 100 for generating three-dimensional (3D) meshes of volumetric in-vivo images of a structure and rendering the 3D mesh of each node connection in the structure for visualization according to some embodiments herein. The system 100 includes an image-capturing device 102, a network 104 and a server 106. The server 106 is hosted on a cloud platform. The image-capturing device 102 includes a magnetic resonance imaging (MRI), and a Computed tomography (CT) device. The server 106 includes a memory 108 and a processor 110. The memory 108 stores a set of instructions. The processor 110 is configured to execute the set of instructions. The server 106 is configured to connect with the image capturing device 102 through the network 104 to receive volumetric in-vivo images of a structure. The network 104 is a wireless or wired. The network 104 may be a combination of a wired and a wireless network. In some embodiments, network 106 is the Internet.

The image capturing device 102 is configured to capture Magnetic Resonance Imaging (MRI) scans and Computed Tomography (CT) scans. The image capturing device 102 process the MRI and CT scans to generate the volumetric in-vivo images of fine structures.

The server 106 may be personal devices including, but not limited to, a handheld device, a mobile phone, a kindle, a Personal Digital Assistant (PDA), a tablet, a computer, a laptop, an electronic notebook, or a Smartphone.

The server 106 is configured to receive the volumetric in-vivo images of the structure from the image capturing device 102. The structure may be an anatomical structure.

The server 106 is configured to pre-process the volumetric in-vivo images by removing noise in the volumetric in-vivo images using at least one preprocessing technique. The preprocessing technique may be normalization method, contrast adjustment method, or artifact removal method. The server 106 is configured to segment the volumetric in-vivo images of the structure into fine structures across the structure using a segmentation method. The segmentation method may be BrainSuite, FreeSurfer or ITK-Snap. The segmentation method identifies and isolates the fine structures within the volumetric in-vivo images. The BrainSuite analyze brain imaging data, and visualization features. The FreeSurfer is widely used for processing the brain MRI images by segmenting the brain's cortical and subcortical structures and allowing for the analysis of structural and functional data. The ITK-Snap provides semi-automatic segmentation using active contour methods, to delineate structures within the brain and other body parts images.

The server 106 generates three-dimensional (3D) meshes by applying a voxel sub-division method on the segmented volumetric in-vivo images. The 3D meshes are generated based on the fine structures within the volumetric in-vivo images. The 3D meshes represent the geometric structure of the segmented areas in a format that can be easily visualized. The server 106 imports the 3D meshes and their corresponding segmentation volumes. The server 106 generates a scene graph representation of the 3D meshes by combining a spatial representation of the 3D meshes. The server 106 incorporates tractography and volume images of the structure into the scene graph representation. For example, the tractography includes visualizing neural tracts that comprise brain connectivity, while volume images provide the context for the 3D meshes.

The server 106 generates the 3D mesh from the segmented fine structures by (i) dividing the segmented fine structures into equal-sized cubic units or voxels, (ii) identifying whether neighboring voxels belong to the same segmented structure or different segmented structures, (iii) detect boundaries between the neighboring voxels belonging to different segmented structures, (iv) determine intersection points along voxel edges where transitions occur between the segmented fine structures for the plurality of voxels belonging to different segmented structures, (v) construct sub-surfaces between the identified intersection points and corresponding voxel positions to define boundary regions, and (vi) aggregate the generated sub-surfaces to construct the 3D mesh representing the boundary of the segmented structure.

The server 106 aligns the 3D meshes with their segmentation volumetric in-vivo images for in-context visualization. This alignment ensures that the 3D models accurately represent the real-time counterparts within the in the scene graph representation. The server 106 renders the 3D mesh of the structure by rendering the scene graph representation and analyzing the connections of nodes within the scene graph representation. Each node represents fine structures with attributes that includes at least one of geometry, or texture.

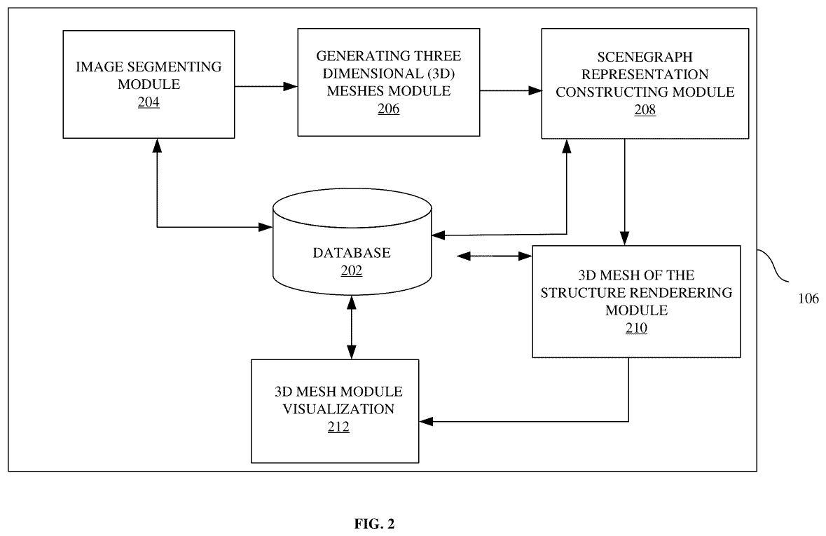

FIG. 2 illustrates an exploded view of a server 106 of FIG. 1 according to some embodiments herein. The scenic route-finding unit 104 includes a database 202, an image segmenting module 204, a generating three dimensional (3D) meshes module 206, a scene graph representation constructing module 208, a 3D mesh of the structure rendering module 210, and a 3D mesh visualization module 212.

The image segmenting module 204 receives volumetric in-vivo images from an image-capturing device 102. The volumetric in-vivo images include medical imaging data from a plurality of Magnetic Resonance Imaging (MRI) scans and Computed tomography (CT) scans. The image segmenting module 204 segments the volumetric in-vivo images of the structure into fine structures within the structure using at least one segmentation method. The generating three-dimensional (3D) meshes module 206 generates 3D meshes of the segmented fine structures by applying a voxel sub-division method. The generating three-dimensional (3D) meshes module 206 generates each 3D mesh represents a geometric structure of the segmented fine structures areas.

The scenegraph representation constructing module 208 constructs a scene graph representation of the 3D meshes by combining the spatial relationships of the 3D mesh.

The 3D mesh of the structure renderering module 210 renders the 3D mesh of the structure by rendering the scene graph representation and analysing the connections of nodes within the scene graph representation. The 3D mesh of the structure renderering module 210 processes each node. Each node represents fine structures with attributes that includes at least one of geometry, or texture. The 3D mesh visualization module 212 provides the 3D meshes of each node connection on a user device for visualization.

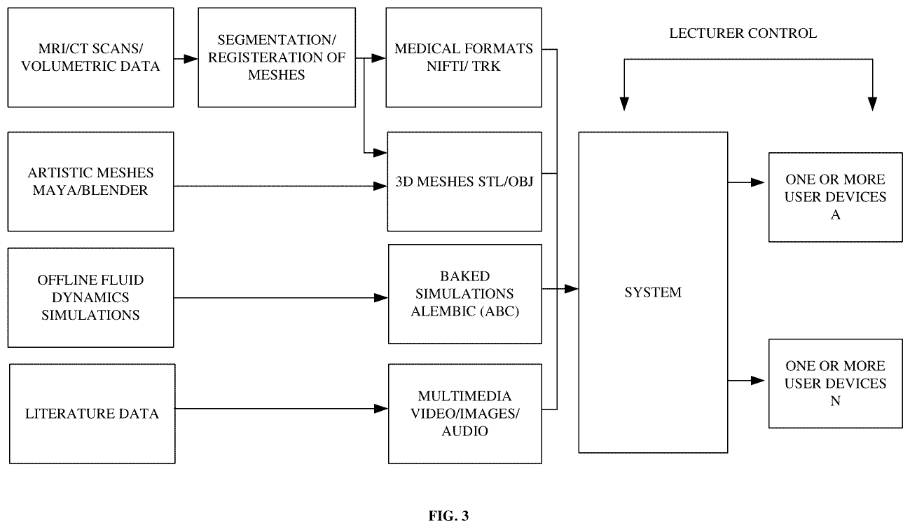

FIG. 3 illustrates workflow of system for interactive 3D visualization according to some embodiments. The system obtains imaging data, such as MRI scans and CT scans, that represent anatomical structures in a human body. The system processes the MRI and CT scans to extract detailed 3D anatomical structures. This involves identifying and isolating key features, such as organs, bones, and tissues, from 2D slices of the MRI scans and CT scans. The system generates 3D mesh that accurately represent the anatomical structures using the extracted data. The 3D mesh is generated by aligning the 3D meshes with their corresponding 2D slices (from the MRI and CT scans) to ensure that the spatial relationships between structures. The custom-built scene graph implementation enables the system to support a wide range of multiple MRI modalities, including NIfTI, tractography, angiography, 3D meshes, and volumetric segmentations. These modalities are stored in database of the server 106 and aligned to common reference, enabling the visualization of structures of interest such as blood vessels or neural tracts, from one modality while simultaneously displaying cross-sectional data from another, such as T1-weighted images. These are displayed in the This functionality analyze and interpret complex anatomical relationships across different imaging types. The system's user-friendly GUI enables educators to interact with the visualizations, switch between 2D and 3D views, and focus on specific structures or slices for context-based learning. The system uses pre-calculated animations in the Alembic format, which avoid heavy real-time processing while ensuring consistent results during playback. The structure may be a brain.

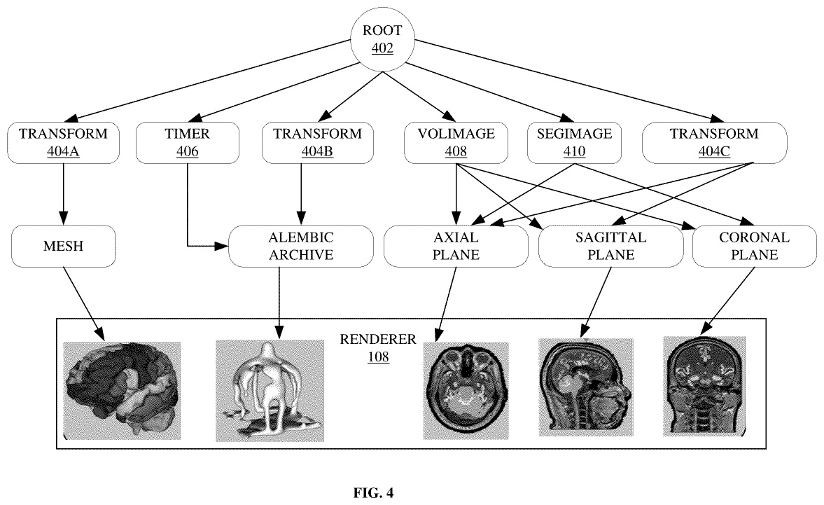

FIG. 4 is an exemplary diagram of a scenegraph representation of a brain according to an embodiment herein. The scenegraph representation of the brain includes a root node at 402, transform nodes 404A, 404B, 404C, timer node 406, volimage node 408, and a segimage node 410. The transform nodes 404A, 404B, 404C are child nodes of the root node 402 and are responsible for applying transformations such as translation, rotation, and scaling to objects. The timer node 406 is used for time-based operations or animations within the scene, updating certain parameters as time progresses. The volimage node 408 represents the volume image data sourced from medical imaging devices like MRI or CT scans. The segimage node 410 represents the data after it has been processed to delineate specific structures within the volume. The alembic archive may be a node for storing a complex set of transformations or for caching the animated state of the SceneGraph for efficient retrieval and playback. The axial, sagittal, and coronal planes are standard planes used in medical imaging to view different cross-sections of the anatomy. The axial plane refers to a horizontal plane, the sagittal plane is a vertical plane that divides the body into left and right parts, and the coronal plane is also a vertical plane that divides the body into front (anterior) and back (posterior) parts.

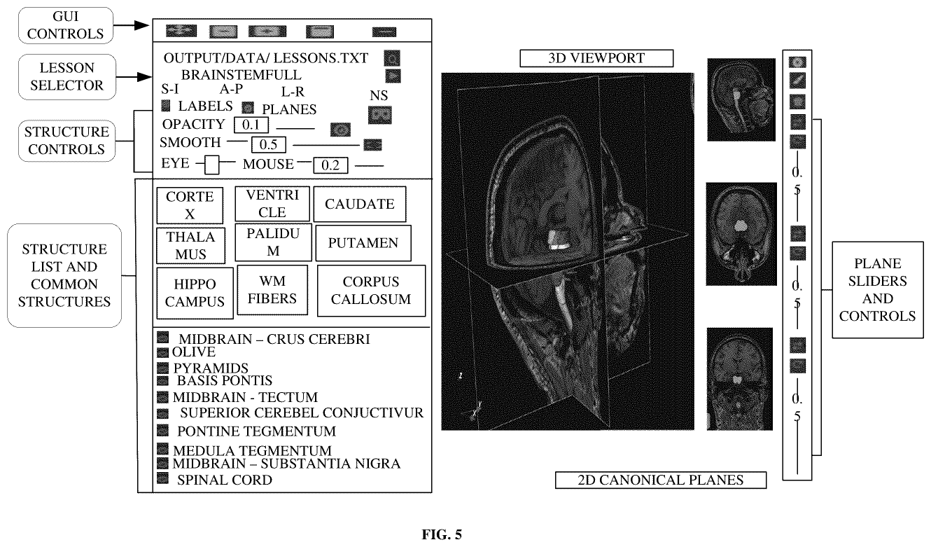

FIG. 5 illustrates Graphical User Interface (GUI) of the system, depicting its renderer and interactive control panels according to some embodiments herein. The system for educational or diagnostic purposes. The system includes the GUI for managing the graphical interface and navigating from different angles. The GUI allows users to interact with the system and manipulate a 3D anatomical visualization.

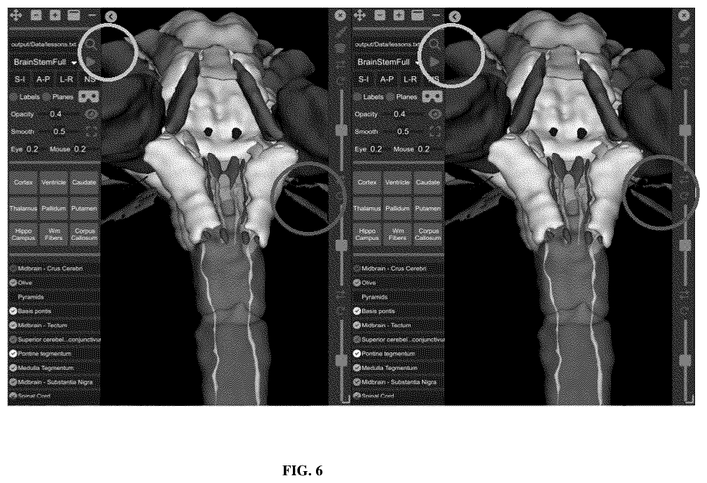

FIG. 6 illustrates a comparative visualization of a 3D brainstem model using a stereoscopic imaging system according to some embodiments. The FIG. 6 shows two panels. The two panels highlight the different images generated for the left and right eyes, as marked by the yellow circles in both views. In both panels, a stereoscopic effect is implemented by generating slightly different perspectives for the left and right eyes (indicated by the yellow circles), enabling the user to perceive the 3D structure of the brainstem. This disparity in visual angles mimics binocular vision and enhances spatial understanding of anatomical relationships. These differences between the images are essential for generating the stereoscopic effect, enabling users equipped with polarization glasses to perceive depth and spatial relationships accurately.

The model is color-coded to distinguish specific anatomical structures, for identification and study of the region. For example, a red-shaded region represents midbrain, specifically crus cerebri, highlighting motor pathway connections, a yellow-shaded region represents corticospinal tracts, specifically critical motor fibers. purple shaded region represents thalamic regions, indicative of sensory relay centers. green and blue shaded regions represent structures of the medulla oblongata and pons, showing functional components of the brainstem.

Both panels include (i) an interactive interface with tools for zooming, rotating, and adjusting the opacity of anatomical structures, (ii) sliders allow users to control parameters such as smoothness, transparency, and interaction sensitivity, ensuring a customized exploration experience, and (iii) color-coded regions and clickable labels for identification and study of specific structures such as the midbrain, pons, medulla oblongata, and substructures like the olive and substantia nigra. The FIG. 6 demonstrates the system's capability to render high-resolution 3D anatomical models with customizable visualization settings, which can be personalized for educational, diagnostic, or research purposes. Additionally, stereo imaging system ensures that users can effectively perceive depth and spatial relationships critical for detailed anatomical analysis.

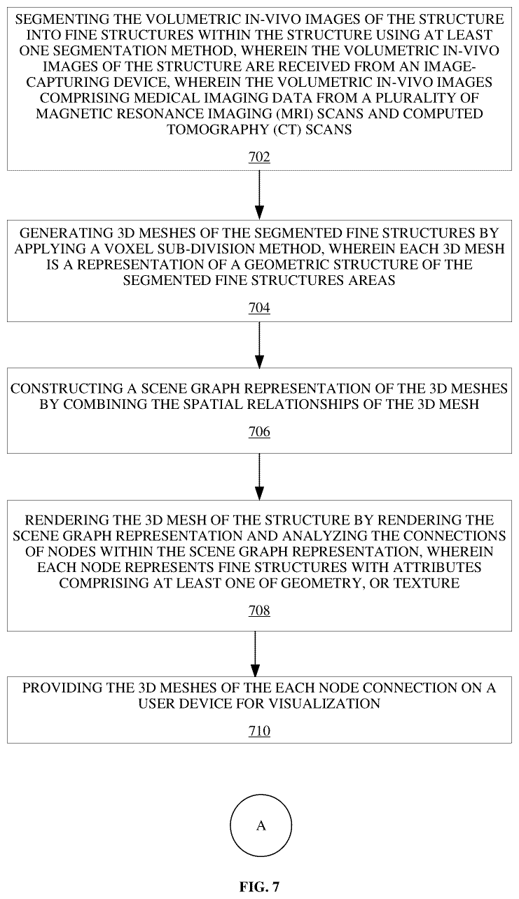

FIG. 7 is a flow diagram that illustrates a method for generating three-dimensional (3D) meshes of volumetric in-vivo images of a structure and rendering the 3D mesh of each node connection in the structure for visualization according to some embodiments herein. At step 702, the volumetric in-vivo images of the structure are segmented into fine structures within the structure using at least one segmentation method. The volumetric in-vivo images of the structure are received from an image-capturing device. The volumetric in-vivo images comprising medical imaging data from a plurality of magnetic resonance imaging (MRI) scans and Computed tomography (CT) scans. At step 704, 3D meshes of the segmented fine structures is generated by applying a voxel sub-division method. Each 3D mesh is a representation of a geometric structure of the segmented fine structures areas. At step 706, a scene graph representation of the 3D meshes is constructed by combining the spatial relationships of the 3D mesh.

At step 708, the 3D mesh of the structure is rendered by rendering the scene graph representation and analyzing the connections of nodes within the scene graph representation. Each node represents fine structures with attributes comprising at least one of geometry, or texture. At step 710, the 3D meshes of each node connection on a user device for visualization is provided.

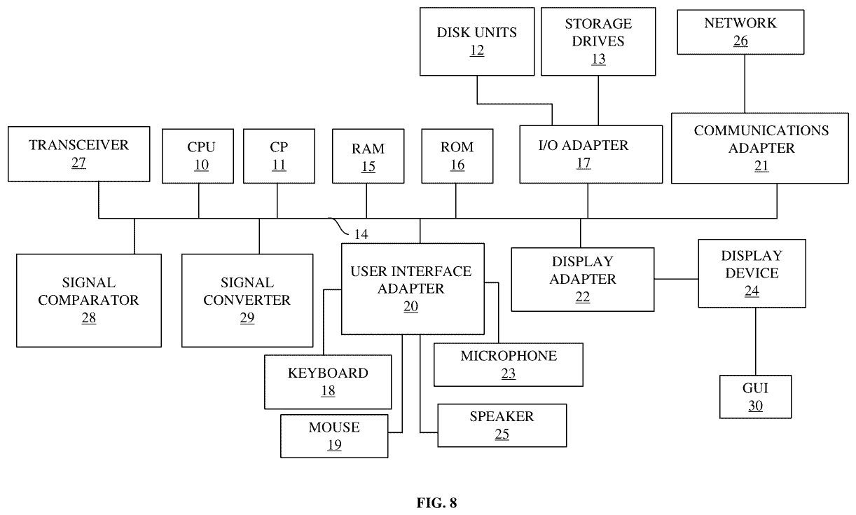

A representative hardware environment for practicing the embodiments herein is depicted in FIG. 8, with reference to FIGS. 1 through 7. This schematic drawing illustrates a hardware configuration of a server 106/computer system/computing device in accordance with the embodiments herein. The system includes at least one processing device CPU 10 that may be interconnected via system bus 15 to various devices such as a random-access memory (RAM) 12, read-only memory (ROM) 16, and an input/output (I/O) adapter 18. The I/O adapter 18 can connect to peripheral devices, such as disk unit 58 and program storage device 50 that are readable by the system. The system can read the inventive instructions on the program storage devices 50 and follow these instructions to execute the methodology of the embodiments herein. The system further includes a user interface adapter 22 that connects a keyboard 28, mouse 50, speaker 52, microphone 55, and/or other user interface devices such as a touch screen device (not shown) to the bus 15 to gather user preference. Additionally, a communication adapter 20 connects the bus 15 to a data processing network 52, and a display adapter 25 connects the bus 15 to a display device 26, which provides a graphical user interface (GUI) 56 of the output data in accordance with the embodiments herein, or which may be embodied as an output device such as a monitor, printer, or transmitter, for example.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope.

What is claimed is:

1. A processor-implemented method for generating three-Dimensional (3D) meshes of volumetric in-vivo images of a structure and rendering the 3D mesh for each node connection in the structure for visualization, comprising:
segmenting the volumetric in-vivo images of the structure into fine structures within the structure using at least one segmentation method, wherein the volumetric in-vivo images of the structure are received from an image-capturing device, wherein the volumetric in-vivo images comprising medical imaging data from a plurality of magnetic resonance imaging (MRI) scans and Computed tomography (CT) scans;
generating 3D meshes by applying a voxel sub-division method on the fine structures, wherein each 3D mesh is a representation of a geometric structure of the segmented fine structures areas;
constructing a scene graph representation of the 3D meshes by combining the spatial relationships of the 3D mesh; and
rendering the 3D mesh of the structure by rendering the scene graph representation and analyzing the connections of nodes within the scene graph representation, wherein each node represents fine structures with attributes comprising at least one of geometry, or texture; and
providing the 3D meshes of each node connection on a user device for visualization.

2. The processor-implemented method of claim 1, wherein the method comprises aligning the 3D mesh of the node with the corresponding segmented volumetric in-vivo images to ensure accurate spatial relationships in the scene graph representation.

3. The processor-implemented method of claim 1, wherein the method comprises enabling a user to interact with the 3D meshes on the user device, wherein the user interaction comprises actions for rotating, zooming, selecting, or modifying the 3D meshes.

4. The processor-implemented method of claim 3, wherein the method comprises updating the scene graph representation and the visualization of the 3D meshes in response to the user interaction to reflect real-time changes to the 3D meshes.

5. The processor-implemented method of claim 1, wherein the method comprises exporting the scene graph representation in an advanced user visualization (AVU) format for storing or sharing the current state of the 3D meshes.

6. The processor-implemented method of claim 1, wherein the method comprises pre-processing the volumetric in-vivo images using at least one preprocessing technique, wherein the at least one preprocessing technique is selected from a normalization method, a contrast adjustment method, or artifact removal method.

7. The processor-implemented method of claim 1, wherein at least one segmentation method is selected from Brain Suite, Free Surfer, and ITK-Snap.

8. The processor-implemented method of claim 1, wherein the method comprises incorporating additional data comprising tractography and volume images of the structure into the scene graph representation to provide context for the 3D meshes.

9. The processor-implemented method of claim 1, wherein the method comprises generating the 3D mesh from the segmented fine structures by,
dividing the segmented fine structures into a plurality of equal-sized cubic units or voxels;
identifying whether neighboring voxels belong to the same segmented structure or different segmented structures;
detect boundaries between the neighboring voxels belonging to different segmented structures;
determining intersection points along voxel edges where transitions occur between the segmented fine structures for the plurality of voxels belonging to different segmented structures;
constructing sub-surfaces between the identified intersection points and corresponding voxel positions to define boundary regions; and
aggregating the generated sub-surfaces to construct the 3D mesh representing the boundary of the segmented structure.

10. A system for generating three-Dimensional (3D) meshes of volumetric in-vivo images of a structure and rendering a 3D mesh of a node of the structure for visualization, comprising:
a server that receives volumetric in-vivo images of a structure through an image-capturing device, wherein the volumetric in-vivo images comprising medical imaging data from a plurality of magnetic resonance imaging (MRI) scans and computed tomography (CT) scans; wherein the server comprises:
a memory comprising a set of instructions; and
a processor that is configured to execute the set of instructions, wherein the processor is configured to:
segment the volumetric in-vivo images into fine structures within the structure using at least one segmentation method;
generate 3D meshes of the segmented fine structures by applying a marching cubes algorithm, wherein the 3D meshes are a representation of a geometric structure of the segmented fine structures areas;
construct a scene graph representation of the 3D meshes by combining spatial relationships of the 3D meshes; and
render the scene graph representation through a renderer module by:
analysing nodes within the scene graph representation, wherein each node represents fine structures with attributes comprising at least one of geometry, or texture; and
generating a visualization of the 3D meshes on a user device based on the analysed node.

11. The system of claim 10, wherein the processor is configured to align the 3D mesh of the node with the corresponding segmented volumetric in-vivo images to ensure accurate spatial relationships in the scene graph representation.

12. The system of claim 10, wherein the processor is configured to enable a user to interact with the 3D meshes on the user device, wherein the user interaction comprises actions for rotating, zooming, selecting, or modifying the 3D meshes.

13. The system of claim 12, wherein the processor is configured to update the scene graph representation and the visualization of the 3D meshes in response to the user interaction to reflect real-time changes to the 3D meshes.

14. The system of claim 10, wherein the processor is configured to export the scene graph representation in an advanced user visualization (AVU) format for storing or sharing the current state of the 3D meshes.

15. The system of claim 10, wherein the processor is configured to pre-process the volumetric in-vivo images using at least one preprocessing technique, wherein the at least one preprocessing technique is selected from a normalization method, a contrast adjustment method, or artifact removal method.

16. The system of claim 10, wherein at least one segmentation system is selected from Brain Suite, Free Surfer, and ITK-Snap.

17. The system of claim 10, wherein the processor is configured to incorporate additional data including tractography and volume images into the scene graph representation to provide context for the 3D meshes.

18. The system of claim 10, wherein the processor is configured to generate the 3D mesh from the segmented fine structures by, dividing the segmented fine structures into a plurality of equal-sized cubic units or voxels,
identifying whether neighboring voxels belong to the same segmented structure or different segmented structures;
detect boundaries between the neighboring voxels belonging to different segmented structures;
determining intersection points along voxel edges where transitions occur between the segmented fine structures for the plurality of voxels belonging to different segmented structures;
constructing sub-surfaces between the identified intersection points and corresponding voxel positions to define boundary regions; and
aggregating the generated sub-surfaces to construct the 3D mesh representing the boundary of the segmented structure.

19. One or more non-transitory computer-readable storage mediums storing one or sequences of instructions, which when executed by one or more processors, causes a processor-implemented method for generating three-Dimensional (3D) meshes of volumetric in-vivo images of a structure and rendering the 3D mesh for each node connection in the structure for visualization, comprising:
segmenting the volumetric in-vivo images of the structure into fine structures within the structure using at least one segmentation method, wherein the volumetric in-vivo images of the structure are received from an image-capturing device, wherein the volumetric in-vivo images comprising medical imaging data from a plurality of magnetic resonance imaging (MRI) scans and Computed tomography (CT) scans;
generating 3D meshes of the segmented fine structures by applying a voxel sub-division method, wherein each 3D mesh is a representation of a geometric structure of the segmented fine structures areas;
constructing a scene graph representation of the 3D meshes by combining the spatial relationships of the 3D mesh; and
rendering the 3D mesh of the structure by rendering the scene graph representation and analyzing the connections of nodes within the scene graph representation, wherein each node represents fine structures with attributes comprising at least one of geometry, or texture; and
providing the 3D meshes of the for each node connection on a user device for visualization.
